(19) United States
(12) Patent Application Publication
(10) Pub. No.: US 2026/0237772 A1
(43) Pub. Date: Aug. 13, 2026

(54) METHODS FOR REGENERATING METAL OXIDES

(71) Applicant: UNIVERSITY OF NOTRE DAME DU LAC, South Bend, IN (US)

(72) Inventors: Khachatur Manukyan, South Bend, IN (US); Armenuhi Yeghishyan, South Bend, IN (US); Ani Aprahamian, South Bend, IN (US)

(21) Appl. No.: 19/153,242

(22) PCT Filed: Feb. 7, 2024
(86) PCT No.: PCT/US2024/014791

§ 371 Date: Aug. 1, 2025

Related U.S. Application Data
(60) Provisional application No. 63/483,557, filed on Feb. 7, 2023.

(51) Int. Cl. H01M 10/54; C01G 51/42; C01G 53/42; C01G 53/502; C22B 3/00; C22B 3/06; C22B 3/16; C22B 3/44; C22B 7/00; C22B 21/00; C22B 26/12; C22B 47/00

(52) U.S. Cl. CPC H01M 10/54; C01G 51/42; C01G 53/42; C01G 53/502; C22B 3/065; C22B 3/165; C22B 3/44; C22B 7/007; C22B 21/0023; C22B 23/0438; C22B 23/0461; C22B 26/12; C22B 47/00; C01P 2002/50; C01P 2002/54; C01P 2002/72; C01P 2006/40

(57) ABSTRACT

A method of regenerating a metal oxide, includes: obtaining the metal oxide by applying a pretreatment process to a lithium ion battery; adding a metal oxide to an inorganic acid or an organic acid to create a dissolved solution; adding a reducing agent to the dissolved solution to generate a metal solution; adding a water-soluble compound to the metal solution; and heating the metal solution to initiate a solution combustion synthesis reaction to obtain a solid.

### CROSS-REFERENCE TO RELATED APPLICATION

This application is a National Stage Entry under 35 U.S.C. § 371 of Int'l App. No. PCT/US24/14791, filed on Feb. 7, 2024, which claims the benefit of U.S. Provisional Pat. App. No. 63/483,557, filed on Feb. 7, 2023. The disclosures of the above-referenced applications are incorporated herein by reference in their entireties.

### TECHNICAL FIELD

The present description relates generally to lithium-ion batteries (LIB) and, more specifically, to methods for recovering, regenerating, and recycling cathode-active materials for fabricating LIBs.

### BACKGROUND

Lithium-ion batteries (LIBs) utilize the reversible reduction of lithium ions to store energy for consumer electronics, electric vehicles (EV), grid-scale electrical storage, and aerospace and military applications. Commercial LIBs consist of an anode, separator, organic liquid electrolyte, and lithium metal oxide cathode. Five major types of LIBs are available in the market with different specifications and cathode-active materials: lithium cobalt oxide (LCO), lithium manganese oxide (LMO), lithium iron phosphate (LFP), lithium nickel cobalt manganese oxide (NMC), and lithium nickel cobalt aluminum oxide (NCA). The demand for several types of LIBs is expanding exponentially for EV and industrial electrical storage applications. Environmental concerns about the accumulation of large amounts of LIBs in waste management and the limited availability of primary resources to make new batteries motivate the recycling of toxic lithium metal oxides from spent LIBs and creating a circular economy.

For instance, WO Pat. No. 2022/084668 describes a method of selectively leaching one or more manganese-containing phases from a mixed-phase battery electrode material. Specifically, the method includes treating the mixed-phase battery electrode material with a solution of an acid with a pKa greater than or equal to −2. The acid acts as both a leaching agent and a reducing agent to form a manganese-containing leachate while leaving at least one phase of the battery electrode material unleached. Either or both of the leachate and the remaining electrode material are then regenerated.

In addition, WO Pat. No. 2020/134773 describes a method for recovering and preparing a lithium iron phosphate cathode material. The method includes: contacting a recycled battery cell material with an acid solution, followed by performing solid-liquid separation to obtain a first liquid phase and an insoluble matter; adjusting the pH value of the first liquid phase, followed by performing solid-liquid separation to obtain a first lithium-containing solution and a first precipitate; mixing the first precipitate and a second lithium-containing solution with an auxiliary agent to obtain a second liquid phase; adjusting the contents of lithium, iron, phosphate, and carbon Li, Fe, P and C in the second liquid phase to obtain a third liquid phase; removing a solvent in the third liquid phase to obtain a lithium iron phosphate precursor; and calcining the precursor in a reducing environment to obtain the lithium iron phosphate cathode material

Further, U.S. Pat. No. 10,741,890 describes a method for recycling lithium iron phosphate batteries. First, a cathode material from exhausted lithium ion batteries are dissolved in a solution for extracting Co (cobalt), Ni (nickel), Al (Aluminum) and Mn (manganese) to produce active cathode materials for new batteries. The solution includes compounds of valuable charge materials such as cobalt, nickel, aluminum and manganese dissolved as compounds from the exhausted cathode material of spent cells. However, LiFePO₄ is a waste stream charge material often discarded due to infeasibility of recycling. LifePO₄ is precipitated as FePO₄ and remains as a by-product, along with graphite and carbon, which are not dissolved into the solution. FePO₄ can be separated from graphite and carbon, FePO₄ can be used to synthesize LiFePO₄ as cathode materials, and graphite can be regenerated as anode materials.

Finally, WO Pat. No. 2022/268792 describes a process for recycling battery materials, in particular lithium ion/polymer batteries. Specifically, the method of recycling battery materials includes: washing a lithium(D)-containing composition that was recovered from used lithium-ion batteries, heating the lithium(D-containing composition in the presence of a reducing agent, suspending the product obtained in in an aqueous or organic suspension medium to obtain a solid reduction product and a lithium(D)-containing solution, and separating the solid reduction material from the lithium(I)-containing solution.

Despite the foregoing, there remains a need for improvements in the art.

### BRIEF DESCRIPTION OF THE DRAWINGS

FIG. 1 is a flow chart illustrating an example method of regenerating a metal oxide in accordance with the various examples disclosed herein.

FIG. 2 is a flow chart illustrating an example method of regenerating a metal oxide in accordance with the various examples disclosed herein.

FIG. 3 is a chart showing XRD (X-ray diffraction) patterns for regenerated and commercial LCO powders obtained in accordance with the various examples disclosed herein.

FIG. 4 is a depiction of regenerated LCO uniform near-spherical particles obtained in accordance with the various examples disclosed herein.

FIG. 5 is a chart showing XRD patterns for regenerated and commercial NCA powders obtained in accordance with the various examples disclosed herein.

FIG. 6 is a depiction of regenerated NCA non-uniform irregular shape particles obtained in accordance with the various examples disclosed herein.

FIG. 7 is a chart showing XRD patterns for regenerated and commercial NMC powders obtained in accordance with the various examples disclosed herein.

### DETAILED DESCRIPTION

The following disclosure of example methods and apparatus is not intended to limit the scope of the description to the precise form or forms detailed herein. Instead, the following disclosure is intended to be illustrative so that others may follow its teachings.

Typically, to recover commercially valuable materials, laboratory and industrial processes use at least one of pyrometallurgy, hydrometallurgy methods, or direct recycling.

The pyrometallurgical process requires preliminary mechanical crushing and milling of spent LIBs, followed by heating in furnaces at temperatures below 500° C. At these temperatures, electrolytes and organic solvents are slowly removed from the spent LIBs. Next, the material is subjected to smelting at 1400-1700° C. to produce alloys (Co, Ni, Cu) and slag (Li₂O or Li₂CO₃). Because the pyrometallurgical method requires high temperatures, this process exhibits high energy consumption, emits harmful gases, fails to recycle the electrolytes, loses significant amounts of the valuable lithium (Li), and needs a subsequent hydrometallurgical process to further separate valuable metals.

The hydrometallurgical process is versatile due to high recovery rates of valuable metals (>98%), high selectivity, and low impurities. Recycling starts with discharging, dismantling, separating, dissolution, and heat treatment to separate cathode-active materials from the spent LIBs. The basic process starts with acid treatment to produce leach liquor, followed by chemical precipitation, solvent extraction, and electrochemical separation. This process separates carbonites, oxalates, or hydroxides of recovered metals, which can be used to prepare cathode materials for new LIBs.

The direct recycling method recovers metal oxides using pretreatment methods, including physical and magnetic separation and thermal processing. Defects in the recovered active material surface and any bulk defects are repaired by re-lithiation or hydrothermal processing. Direct recycling is a relatively simple process, and materials can be reused after regeneration for LCO cathodes. Recycling more complex metal oxides (NMC or NCA) through this process is challenging due to the mixture of more than one active material.

There is growing demand in the art for cost-effective, scalable methods for recovering cathode-active materials, regenerating them in a simple process, and reusing them in the preparation of new LIBs.

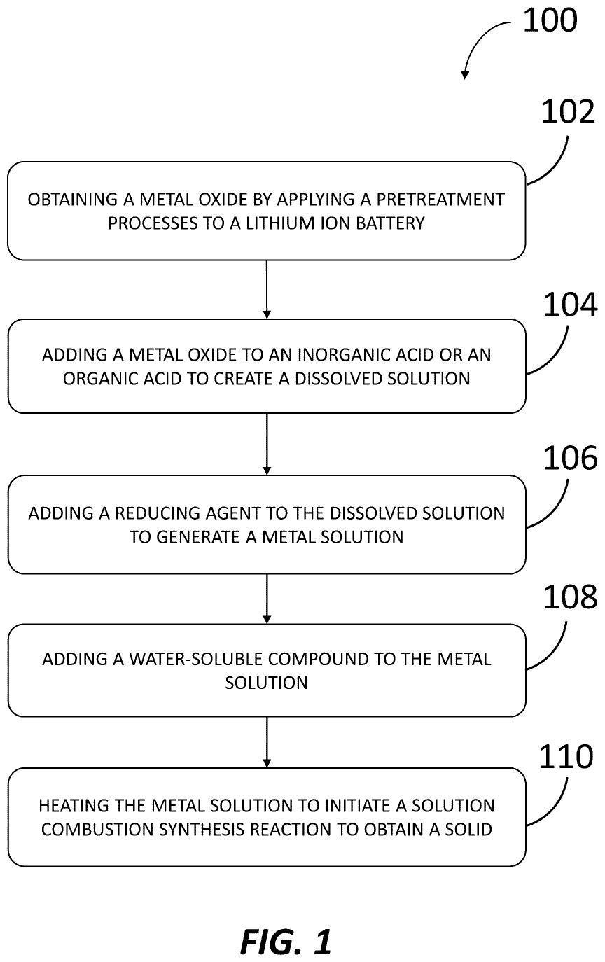

FIG. 1 is a flow chart illustrating an example method 100 of regenerating a metal oxide in accordance with the various examples disclosed herein. As shown in FIG. 1, the example method 100 generally includes obtaining a metal oxide (an obtaining step 102), adding the metal oxide to an acid (an adding step 104), adding a reducing agent (an adding step 106), adding a water soluble compound (an adding step 108), and heating to obtain a solid (a heating step 110). More precisely, in this example, the obtaining step 102 includes obtaining a metal oxide by applying a suitable pretreatment process to a lithium ion battery. In this context, the lithium ion battery may be a used LIB, a spent LIB, or any other suitable LIB. In this example, the metal oxide comprises at least one of cobalt, manganese, iron, nickel, aluminum, or titanium, while in other examples, different metal oxides may be obtained depending upon the LIB construction.

The example pretreatment process includes discharging, dismantling, separation, and dissolution of charge collectors, while other suitable pretreatment processes may be utilized as desired. More specifically, discharging releases residual electricity in spent LIBs to ensure later pretreatment and treatment steps are safe, while dismantling isolates major components of spent LIBs such as current collectors, plastics, and metals. Separation may be physical separation (e.g., gravity separation, magnetic separation, size reduction, etc.) to sort different components of spent LIBs and dissolution decomposes binders to detach active materials from current collectors.

Once the obtaining step 102 is completed, the example adding step 104 includes adding a metal oxide to an inorganic acid or an organic acid to create a dissolved solution. “Adding” as used herein, refers to bringing two or more components into immediate or close proximity, or into direct contact. In some examples, the adding step 104 includes heating the metal oxide in the inorganic acid or the organic acid at a temperature of 40° C. to 90° C. In some examples, the inorganic acid comprises at least one of nitric acid, sulfuric acid, hydrochloric acid, or phosphoric acid. In some examples, the organic acid comprises at least one of citric acid, acetic acid, maleic acid, or oxalic acid. As will be appreciated, the adding step 104 may also include stirring (or mixing) the metal oxide in the inorganic acid or the organic acid to create a dissolved solution. The dissolved solution may also be filtered to separate out undissolved materials. Reflux apparati may be used to prevent water evaporation in the dissolved state. Additionally, dissolving materials with mineral acids (such as nitric acid) may release heat that decreases the need for externally applied heat. As such, thermocouple-guided controllers may be used to monitor and control the amount of external heat required to obtain a temperature of 40° C. to 90° C.

Once the adding step 104 is completed, a reducing agent is added to the dissolved solution to generate a metal solution at the adding step 106. In general, the reducing agents are added to the dissolved solution to reduce oxidation states of the dissolved metals. In some examples, the reducing agent includes hydrogen peroxide. In some instances, the example adding step 106 also includes adjusting a concentration of metal ions in the dissolved solution with at least one of a nitrite, a sulfate, a citrate, or an oxalate. The concentration of metal ions in the dissolved solution may be measured by standard analytical methods (e.g., ICP). In some examples, adjusting the metal concentrations may be controlled by adding nitrites, sulfates, citrates, oxalates, or other materials.

Once the adding step 106 is completed, a water-soluble compound is added to the metal solution at the adding step 108. In this example, the water-soluble compound comprises at least one of acetone, acetylacetone, carbohydrazide, diformyl hydrazide, dihydrazide, ethanol, ethyleneglycol ethoxyethanol, glucose, glycerol, glycine, hexamethylenetetramine, hydrazine, isopropanol, maleic hydrazide, malonic acid, methoxyethanol, oxalic acid, sucrose, or urea. It will be understood, however, that is other examples, the water-soluable compound may be any suitable compound as desired. In addition, the water-soluable compounds may be mixed in the metal solution by magnetic steering or other methods of mixing liquids and solids.

Once the adding step 108 is completed, the heating step 110 includes heating the metal solution to initiate a solution combustion synthesis reaction to obtain a solid. In some examples, the heating of the metal solution includes a first heating at a first temperature of 80° C. to 95° C. The first heating may occur on a hot plate or in any other suitable heating device, (e.g., as drying, curing, or dehydration ovens) to remove excessive amounts of solvents and obtain concentrated solutions or gel-type materials. The duration of the first heating at the first temperature depends on the initial solution volume and the heating device used, which can extend the heating duration from minutes to hours. In some examples, the heating of the leach liquor includes a second heating at a second temperature of 180° C. to 300° C. The second heating may occur on hot plates or any suitable furnace (e.g., rotary, box, muffle, tube, batch, etc.). A rotary furnace or tube furnace may be used to prepare larger amounts of materials in a continuous process. Furthermore, the second temperature depends on the concentration and chemical compositions of the concentrated solutions or gel-type materials. The second heating may initiate a rapid exothermic chemical reaction within minutes, converting the metal solution into a solid. In some examples, the second heating is followed by a third heating which includes heating the solid at a third temperature of 600° C. to 900° C. for a duration of 15 minutes to 240 minutes. This third heating step may occur in a furnace (e.g., rotary, box, muffle, tube, batch, etc.) to obtain final regenerated cathode-active materials for LIBs. Depending on the metal oxide type, such as NMC, this third heating may be performed in an inert atmosphere (e.g., nitrogen gas) to prevent the oxidation of certain metals.

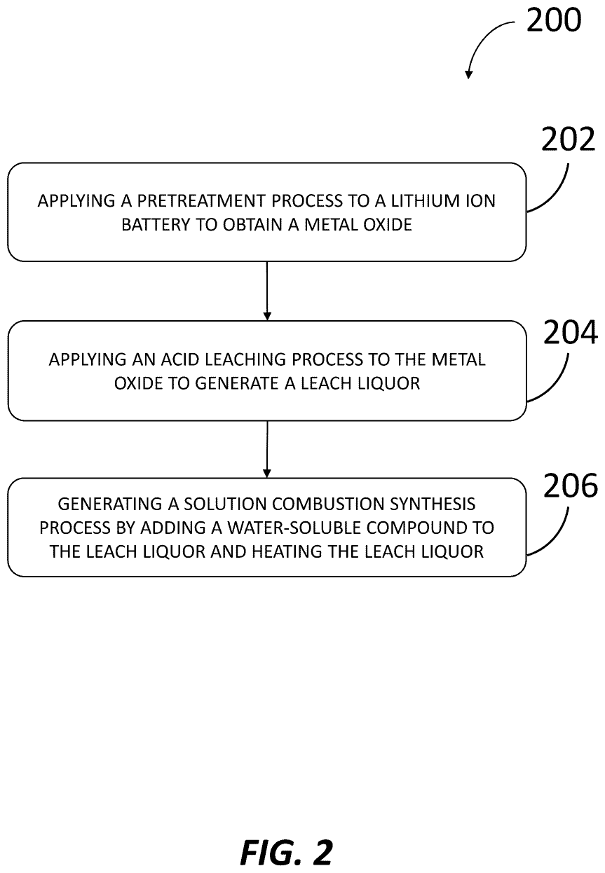

FIG. 2 is a flow chart illustrating an example method 100 of regenerating a metal oxide in accordance with the various examples disclosed herein. As shown in FIG. 2, the example method 200 includes: applying a pretreatment process (an applying step 202), applying an acid leaching process (an applying step 204), and generating a solution combustion synthesis process (a generating step 206). More precisely, in this example, the applying step 202 includes applying a suitable pretreatment process to the lithium-ion battery to obtain a metal oxide. In this context, the lithium ion battery may be a used LIB, a spent LIB, or any other suitable LIB. In some examples, the pretreatment process includes discharging, dismantling, separation, and dissolution of charge collectors, while other suitable pretreatment processes may be utilized as desired. In this example, the metal oxide comprises at least one of cobalt, manganese, iron, nickel, aluminum, or titanium, while in other examples, different metal oxides may be obtained depending upon the LIB construction.

Once the applying step 202 is completed, the example applying step 204 includes applying an acid leaching process to the metal oxide to generate a leach liquor. In some examples, the applying step 204 includes adding the metal oxide to an inorganic acid or an organic acid to create a dissolved solution, and adding a reducing agent to the dissolved solution to generate a metal solution. The metal oxide may be heated in the inorganic acid or the organic acid at a temperature of 40° C. to 90° C. In some examples, the inorganic acid comprises at least one of nitric acid, sulfuric acid, hydrochloric acid, or phosphoric acid. In some examples, the organic acid comprises at least one of citric acid, acetic acid, maleic acid, or oxalic acid. As will be appreciated, the metal oxide may be added by stirring (or mixing) the metal oxide in the inorganic acid or the organic acid to create a dissolved solution. In some examples, the dissolved solution is filtered to separate out undissolved materials. Reflux apparati may be used to prevent water evaporation in the dissolved state and thermocouple-guided controllers may be used to monitor and control the amount of external heat required to obtain a temperature of 40 °° C. to 90° C. In this example, reducing agents are added to the dissolved solution to reduce oxidation states of the dissolved metals. In some examples, the reducing agent includes hydrogen peroxide. In some instances, the applying step 204 also includes adjusting a concentration of metal ions in the dissolved solution with at least one of a nitrite, a sulfate, a citrate, or an oxalate. The concentration of metal ions in the dissolved solution may be measured by standard analytical methods as described above. In some examples, adjusting the metal concentrations may be controlled by adding nitrites, sulfates, citrates, oxalates, or other materials.

Once the applying step 204 is completed, the generating step 206 generates a solution combustion synthesis process by adding a water-soluble compound to the leach liquor and heating the leach liquor. In this example, the water-soluble compound comprises one of acetone, acetylacetone, carbohydrazide, diformyl hydrazide, dihydrazide, ethanol, ethyleneglycol ethoxyethanol, glucose, glycerol, glycine, hexamethylenetetramine, hydrazine, isopropanol, maleic hydrazide, malonic acid, methoxyethanol, oxalic acid, sucrose, or urea. It will be understood, however, that is other examples, the water-soluable compound may be any suitable compound as desired. In this example, the heating of the leach liquor includes a first heating at a first temperature of 80° C. to 95° C. The first heating may occur on a hot plate or in any other suitable heating device, (e.g., as drying, curing, or dehydration ovens) to remove excessive amounts of solvents and obtain concentrated solutions or gel-type materials. The duration of the first heating at the first temperature depends on the initial solution volume and the heating device used, which can extend the heating duration from minutes to hours. In this example, the heating of the leach liquor further includes a second heating at a second temperature of 180° C. to 300° C. The second heating may occur on hot plates or any suitable furnace (e.g., rotary, box, muffle, tube, batch, etc.). A rotary furnace may be used to prepare larger amounts of materials in a continuous process. The second temperature depends on the concentration and chemical compositions of the concentrated solutions or gel-type materials. The second heating is used to initiate a rapid exothermic chemical reaction within minutes, which converts the metal solution into a solid. In other examples, the second heating may be followed by a third heating which includes heating the solid at a third temperature of 600° C. to 900° C. for a duration of 15 minutes to 240 minutes. This third heating step may occur in a furnace (e.g., rotary, box, muffle, tube, batch, etc.) to obtain final regenerated cathode-active materials for LIBs. Depending on the metal oxide type, such as NMC, this third heating may be performed in an inert atmosphere (e.g., nitrogen gas) to prevent the oxidation of certain metals.

### EXAMPLE 1

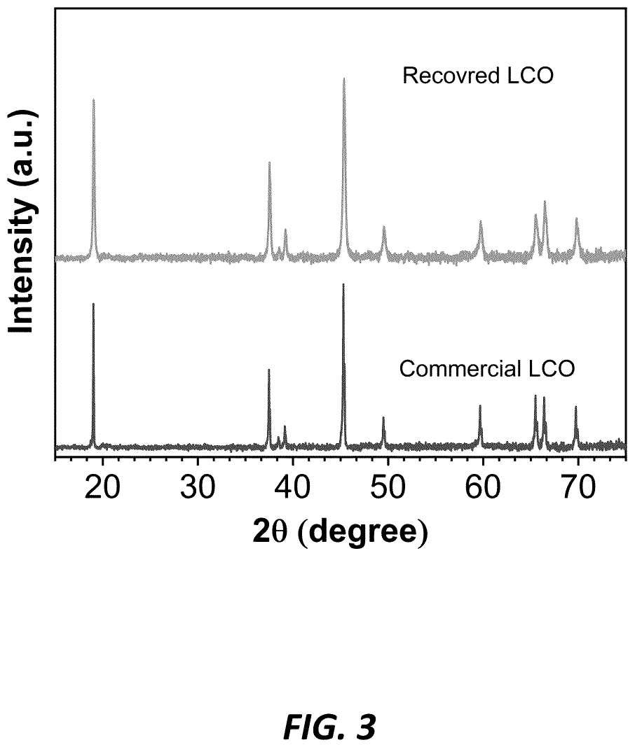

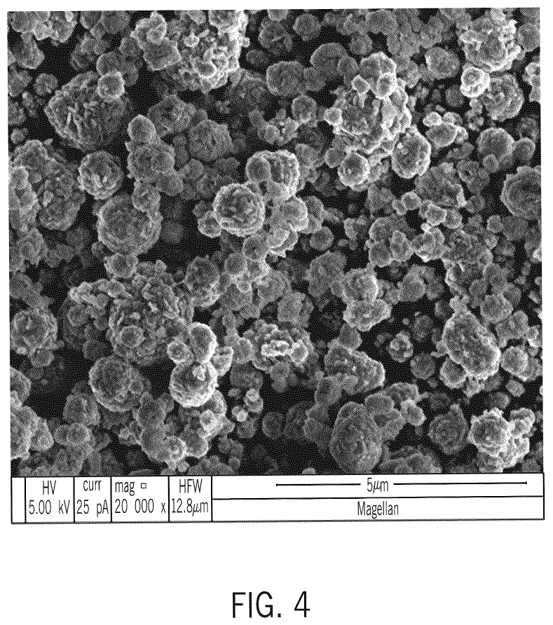

Battery-recovered LCO cathode-active material (5 g) was dissolved in 250 ml L of HNO₃ (1 M) and mixed with magnetic stirrer while heating the solution to 75° C. The dissolution released heat and external heating was controlled to prevent overheating. 5 ml H₂O₂ (30%) was added to solution in three portions every hour. After dissolution, 1.1 g of hexamethylene-tetramine was added to the solution and mixed for 10 minutes. Then, the obtained reactive solution was heated on a hot plate for 10 minutes to initiate the solution combustion synthesis reaction. The reaction took less than one minute. After the reaction, the resulting material was analyzed by X-ray diffraction (XRD). The XRD patterns for the regenerated and commercial LCO powders with similar diffraction peaks is shown in FIG. 3. The regenerated LCO consists of uniform near-spherical particles with an average size of 1 μm, as shown in FIG. 4.

### EXAMPLE 2

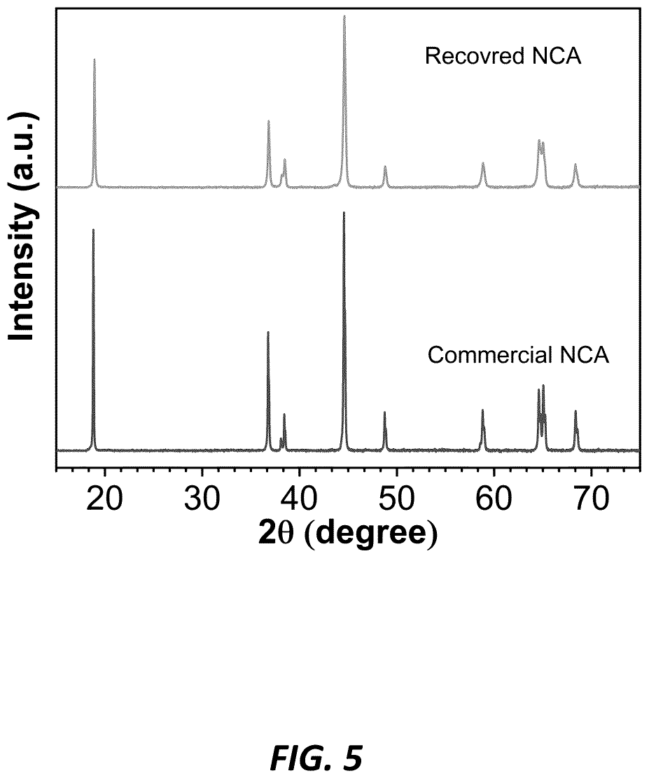

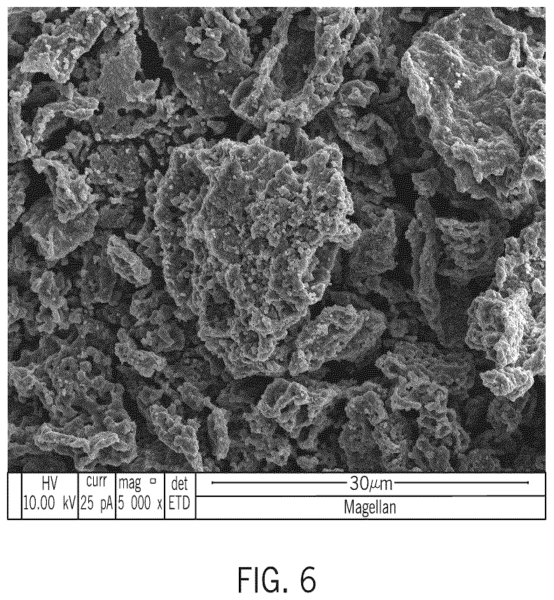

Battery-recovered NCA (with a nominal composition of LiNi_{0.8}Co_{0.15}Al_{0.05}O₂) cathode-active material (24 g) was dissolved in a solution containing 75 ml of HNO₃(70%) and 75 ml of distilled water at 75° C. The dissolution released heat and external heating was controlled to prevent overheating. 20 ml H₂O₂ (30%) was added to the solution in three portions every 5 minutes. After dissolution, 74 g of glucose was added to the solution and mixed for 5 minutes. The obtained solution (379 g) was heated at 80° C. for four hours on a large hot plate. Brownish-red nitrogen dioxide was released for roughly 10 minutes during the second hour of heating. This nitrogen dioxide gas was absorbed by water +hydrogen peroxide and diluted nitric acid solutions and used to dissolve a new NCA batch. This heating caused the evaporation of water and yielded a gel (150 g). Next, 40 g of gel was poured into quarts, stainless-steel, or alumina boats, and placed in a colder segment of the preheated tube furnace. After a short preheating, the combustion process was initiated and propagated through the gel. Upon complete combustion, the boat was moved into the warmer segment of the furnace and heated at 700° C. for 1.5 hours. During the combustion stage and heat treatment, an airflow of 150 ml/min was allowed into the tube to facilitate the complete regeneration of NCA cathode materials. The resulting material was analyzed by XRD. The XRD patterns for the regenerated materials, such as commercial NCA powder, is shown in FIG. 5. The regenerated NCA consists of non-uniform, irregular-shaped porous particles with an average size of 5-10 μm, as shown in FIG. 6.

### EXAMPLE 3

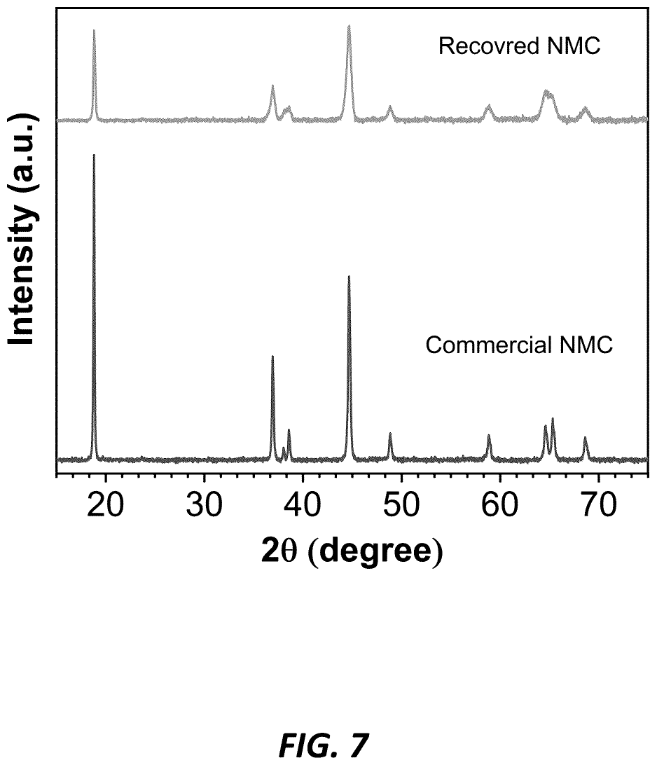

NMC (with a nominal composition of Li_{1.05}Ni_{1/3}Mn_{1/3}Co_{1/3}O₂) cathode-active material (24 g) was dissolved in 75 ml of HNO₃(70%) and 75 ml of distilled water and mixed with a magnetic stirrer while heating the solution to 75° C. The dissolution released heat, and external heating was controlled to prevent overheating. 20 ml H₂O₂ (30%) was added to the solution in three portions every 5 minutes. After dissolution, 74 g of glucose was added to the solution and mixed for 5 minutes. Then, a 25 ml ammonium hydroxide (30%) solution was added. The obtained solution (392 g) was heated on a large hot plate at 80° C. for four hours. This heating caused the evaporation of water and obtained a gel (190 g). Next, 40 g of gel was poured into quarts or stainless-steel boats and placed in a colder segment of the preheated tube furnace. After a short preheating, the combustion process was initiated and propagated through the gel. Upon complete combustion, the boat was moved into the warmer segment of the furnace and heated at 850° C. for 30 minutes. During the combustion stage and heat treatment, an airflow of 150 ml/min was allowed into the tube to facilitate the complete regeneration. The resulting material was analyzed by XRD. The XRD patterns for the regenerated materials, such as commercial NMC powder, is shown in FIG. 7.

### EXAMPLE 4

Battery-recovered LFP cathode-active material (1.6 g) was dissolved in 26 ml preheated (80° C.) oxalic acid solution (0.33 mol/L) and mixed with a magnetic stirrer while heating the solution to 80° C. After one hour of such treatment, the obtained black liquor was allowed to cool to room temperature, and 1.2 g glucose monohydrate and 4.8 g ammonium nitrate (NH₄NO₃) were added to the liquor and mixed for 30 minutes. The liquor (24.5 grams) was heated on a hot plate at 90° C. for one hour. This heating caused the evaporation of water and obtained a black concentrated slurry (past) with a total mass of 10 g. Next, 10 g of past was placed into quarts, stainless-steel, or alumina boats and transferred in a colder segment of the preheated tube furnace in airflow of nitrogen (200 ml/min), however argon airflow (200 ml/min) may also be used. After a short preheating (2-3 minutes), the smoldering combustion process was initiated and propagated through the past. Upon complete combustion, the boat was moved into the warmer segment of the furnace and heated at 700° C. for three hours. Nitrogen airflow (200 ml/min) was allowed into the tube to prevent the oxidation of regenerated material, however argon airflow (200 ml/min) may also be used.

While this disclosure has described certain examples, it will be understood that the claims are not intended to be limited to these examples except as explicitly recited in the claims. On the contrary, the instant disclosure is intended to cover alternatives, modifications and equivalents, which may be included within the spirit and scope of the disclosure. It is also be understood that the claims are not limited to the regeneration of LIB cathode materials on larger scales using larger equipment. Furthermore, in the detailed description of the present disclosure, numerous specific details are set forth in order to provide a thorough understanding of the disclosed examples. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

What is claimed is:

1. A method of regenerating a metal oxide, comprising:
obtaining the metal oxide by applying a pretreatment process to a lithium ion battery;
adding a metal oxide to an inorganic acid or an organic acid to create a dissolved solution;
adding a reducing agent to the dissolved solution to generate a metal solution;
adding a water-soluble compound to the metal solution; and
heating the metal solution to initiate a solution combustion synthesis reaction to obtain a solid.

2. The method of claim 1, wherein the adding of the metal oxide further comprises heating the metal oxide in the inorganic acid or the organic acid at a temperature of 40° C. to 90° C.

3. The method of claim 1, wherein the heating of the metal solution occurs at a temperature of 80° C. to 95° C.

4. The method of claim 1, wherein the heating of the metal solution occurs at a temperature of 180° C. to 300° C.

5. The method of claim 1, wherein the metal oxide comprises at least one of cobalt, manganese, iron, nickel, aluminum, or titanium.

6. The method of claim 1, wherein the inorganic acid comprises at least one of nitric acid, sulfuric acid, hydrochloric acid, or phosphoric acid.

7. The method of claim 1, wherein the reducing agent comprises hydrogen peroxide.

8. The method of claim 1, wherein the adding of the reducing agent further comprises adjusting a concentration of metal ions in the dissolved solution with at least one of a nitrite, a sulfate, a citrate, or an oxalate.

9. The method of claim 1, wherein the organic acid comprises at least one of citric acid, acetic acid, maleic acid, or oxalic acid.

10. The method of claim 1, wherein the water-soluble compound comprises at least one of acetone, acetylacetone, carbohydrazide, diformyl hydrazide, dihydrazide, ethanol, ethyleneglycol ethoxyethanol, glucose, glycerol, glycine, hexamethylenetetramine, hydrazine, isopropanol, maleic hydrazide, malonic acid, methoxyethanol, oxalic acid, sucrose, or urea.

11. The method of claim 1, further comprising heating the solid at a temperature of between 600° C. and 900° C. for a duration of 15 minutes to 240 minutes.

12. A method of recycling a lithium-ion battery comprising:
applying a pretreatment process to the lithium-ion battery to obtain a metal oxide;
applying an acid leaching process to the metal oxide to generate a leach liquor; and
generating a solution combustion synthesis process by adding a water-soluble compound to the leach liquor and heating the leach liquor.

13. The method of claim 12, wherein the heating of the leach liquor occurs at a temperature of 80° C. to 95° C.

14. The method of claim 12, wherein the heating of the leach liquor occurs at a temperature of 180° C. to 300° C.

15. The method of claim 12, wherein the metal oxide comprises one of cobalt, manganese, iron, nickel, aluminum, or titanium.

16. The method of claim 12, wherein the water-soluble compound comprises one of acetone, acetylacetone, carbohydrazide, diformyl hydrazide, dihydrazide, ethanol, ethyleneglycol ethoxyethanol, glucose, glycerol, glycine, hexamethylenetetramine, hydrazine, isopropanol, maleic hydrazide, malonic acid, methoxyethanol, oxalic acid, sucrose, or urea.

17. The method of claim 12, wherein the acid leaching process comprises:
adding the metal oxide to an inorganic acid or an organic acid to create a dissolved solution; and
adding a reducing agent to the dissolved solution to generate a metal solution.

18. The method of claim 17, wherein the inorganic acid comprises at least one of nitric acid, sulfuric acid, hydrochloric acid, or phosphoric acid.

19. The method of claim 17, wherein the organic acid comprises at least one of citric acid, acetic acid, maleic acid, or oxalic acid.

20. The method of claim 17, wherein the adding of the reducing agent further comprises adjusting a concentration of metal ions in the dissolved solution with at least one of a nitrite, a sulfate, a citrate, or an oxalate.
